(19) United States
(12) Patent Application Publication
(10) Pub. No.: US 2008/0278879 A1
(43) Pub. Date: Nov. 13, 2008

(54) Static Electricity Eliminator, Particularly for the Treatment of Polymers

(75) Inventor: Joseph Taillet, Boulogne-Billancourt (FR)

Correspondence Address: OBLON, SPIVAK, MCCLELLAND MAIER & NEUSTADT, P.C., 1940 DUKE STREET, ALEXANDRIA, VA, 22314, US

(73) Assignee: VALITEC, BOULOGNE-BILLANCOURT (FR)

(21) Appl. No.: 10/577,927

(22) PCT Filed: Apr. 26, 2005
(86) PCT No.: PCT/FR05/01027

§ 371 Date: May 1, 2006

(30) Foreign Application Priority Data
May 7, 2004 (FR) 0404941

(51) Int. Cl. H05F 3/00

(52) U.S. Cl. 361/213

(57) ABSTRACT

A static electricity eliminator including at least one nozzle having a body defining a supersonic tuyere for pressure reduction of a compressed gas, a corona tip located close to the neck of the tuyere, and an electric supply circuit connected to the tip of the corona. The tip includes a surgical needle made of steel with chrome. The tip thereof has a diameter of less than 30 micrometers. The eliminator can be used to improve the treatment of polymers.

The invention relates to a static electricity eliminator in particular for improving the processing of polymers.

The problem of eliminating electrostatic charges is very considerable in various fields and in particular in that of polymer production.

Polymers are indeed highly insulating in electrical terms and they can keep static electricity on their surface for periods of plural weeks. The generation of electrostatic charges by friction always accompanies the operations necessary to the production of these polymers, and in particular pneumatic conveying. This operation is made necessary by the fact that the polymerisation reactors are, for safety reasons, remote from the workstations of personnel. The polymer leaves the reactor in the form of granules and is conveyed, usually by pneumatic conveying, to bays for bagging or bulk container-filling.

This conveying produces partial abrasion of the granules, which generates fines and partial melting due to heating of granules as they are drawn along walls. The smears left by the molten product solidify in the form of filaments known as “angels' hair”, which have a diameter of the order of tenths of a millimetre and a length of several centimetres, or in the form of tow having a diameter of plural millimetres and a length of more than 10 cm. The fines, angels' hair and tow are waste products which downgrade the quality of the product and which should, in principle, be separated from the granules by pneumatic devices. However, the friction of the products on the walls of the plant generates electrostatic charges both on the granules and the waste products.

The existence of electrostatic charges on these insulating materials produces forces of cohesion which have the effect of severely reducing and in some cases eliminating the effectiveness of the pneumatic devices for separating the granules from the waste. The existence of these electrostatic charges gives rise to adverse effects which for the manufacturer translate into three very constraining consequences:

1) The waste is found in the product supplied to the clients, leading to numerous returns of batches refused by the buyer.
2) The waste sticks together, blocks screens and filtering devices and ducts, resulting in halts in production for cleaning of the plant, maintenance which is made difficult by the need to dismantle and clean dismantled parts, and then reassemble the same, which leads to an increase in the production costs.
3) The unblocking of conduits by blowing through compressed air leads to dispersion, then accumulation of the waste on the factory floors, which leads to pollution of the environment, fire risk and risk of falling for the personnel.

It is therefore very important for the profitability of the production to eliminate static electricity produced during the manufacture of polymers.

There is known furthermore, from the French Patent 80 21 977 (publication number 2 492 212), a static electricity eliminator comprising at least one injector having a body defining a supersonic nozzle for holding a compressed gas, a corona point located close to the throat of the nozzle and an electricity supply circuit connected to the corona point.

The eliminator, which is the subject of the French Patent 80 21 977, takes steps known from the prior art, in particular the creation in the vicinity of the throat of a supersonic nozzle of nanometric aerosols of ice formed by condensation of water vapour on ions produced by a corona discharge, as well as the driving of these aerosols by a supersonic jet. The essential feature of the patent cited is in the process which makes it possible to obtain in the jet, where the metal point which produces the corona discharge is supplied with alternating current, equal positive and negative currents, which ensures the electric neutrality of the mixture of ions supplied by the injector. This neutrality is ensured on the one hand by virtue of the insulating covering of the throat of the nozzle and of the part of the nozzle outside the injector, and on the other hand by insertion of a capacitor in the supply circuit of the point.

The application of the invention which is the subject of the French Patent 80 21 977 has been tried more than once without success. Indeed, the hardware constructed according to the teaching of this patent had neither the efficiency nor the necessary reliability for an industrial tool intended to operate day and night in production units of the petrochemical industry.

Moreover, the invention which is the subject of the aforesaid French Patent has obviously not been conceived for an application particular to polymers. The description of the patent furthermore does not mention this particular application.

Consequently, it is an object of the invention to propose a static electricity eliminator which is intended in particular to improve the processing of polymers.

It is a further object of the invention to procure such a static electricity eliminator which can be applied effectively and reliably in production units of the petrochemical industry.

The invention proposes to this end a static electricity eliminator of the type defined in the introduction, which takes features of the basis of the invention of the French Patent 80 21 977, but adds essential features to achieve the above-mentioned objects and to permit an application, in particular in the field of the processing or production of polymers.

According to an essential feature of the invention, the corona point is formed by a surgical chromium-steel needle, whose point has a diameter of less than 30 micrometres. After numerous tests, it was found that the use of such a point made it possible to obtain an aerosol particularly appropriate to the processing of polymers.

Furthermore, such a surgical needle has the advantage of being easily available commercially and of being replaced easily during maintenance.

Finally, a precise definition of the material and structure of the point which generates the corona discharge is equally important in order to achieve the permanence of settings and the efficiency of the process over long periods, a quality which is indispensable for the adoption of the process in the factories of polymer manufacturers.

According to another feature of the invention, the supersonic nozzle is composed of a metal insert comprising a hollow cylindrical part extending forward by a conical part ending with a flange oriented inward, the whole being moulded from an epoxy insulator so as to cover with insulation the conical part and its flange, both on the outside and on the inside, and the front of the inner cylindrical part.

Advantageously, the hollow cylindrical part forming the metal insert of the nozzle is equipped at its rear with a female thread and comprises an outer wall having the same diameter as a cylindrical metal tube which protects a front part of the injector and which is located adjacent to the metal insert.

The needle is advantageously supported by an insulating tube or mantle having a threaded front part adapted to screw into the female thread of the rear end of the metal insert of the nozzle.

The eliminator advantageously comprises a metal ring contrived to slide with gentle friction over the rear part of the nozzle and over the cylindrical metal tube and to be fixed there in a selected position so as to ensure conductive contact between the metal insert of the nozzle and the metal tube.

The insulating tube or mantle is equipped on the inside with a fixing device which is formed by two metal rings pierced with an aperture to allow the passage of the compressed gas, at least one of these metal rings being equipped with a thread.

The needle is then fixed in a threaded support contrived to be screwed or unscrewed in the fixing device in order to effect approximate adjustment of the position of the needle point relative to the nozzle throat.

Furthermore, the relative position of the needle point and of the throat of the nozzle can be adjusted rapidly and precisely without dismantling the injector, by screwing or unscrewing the nozzle at the front end of the insulating tube or mantle defined above, which surrounds the needle support.

In order to permit the fixing of the needle to its support, this advantageously has a conical recess formed at a rear end located opposite the point.

By virtue of this feature, the rear end of the needle can be engaged inside a recess formed as a hollow cylinder at the front of this cylindrical metal support, this recess having a diameter greater by several hundredths of a millimetre than that of the needle, the rear end of the needle being fixed in the cylindrical recess by widening the walls of the conical recess of the needle by crushing of its walls between the inner wall of the support and a ball of a ball-point pen of the appropriate diameter.

According to a further feature of the invention, the device comprises a metal T-shaped connection allowing the introduction of compressed gas into the injector, this connection being interposed between the metal tube protecting the front of the injector and another metal tube protecting the rear of the injector, so as to form a contact with the tubes to ensure the continuity of the conducting link between the front and rear of the injector.

According to yet another feature of the invention, the metal tube protecting the rear of the injector is in contact with a metal fixing device intended to anchor a coaxial cable for supplying a high voltage to the needle, this metal fixing device being in contact itself with a metal casing of this cable, which is connected to earth.

Further additional or alternative features of the invention are indicated below:
the electricity supply circuit of the corona needle comprises two components in series between the needle and the secondary winding of a transformer which supplies the same with current, notably a capacitor with a value of between 20 pF and 200 pF, and a resistor with a value of between 1 MΩ and 100 MΩ;
the capacitor and the resistor are located in an insulating envelope comprising apertures formed for the passage of input and output connections which are covered with an insulating thermosetting polymer in order to prevent the penetration of damp air into the envelope;
the coaxial cable supplying the high voltage ends on the side of an electricity supply circuit with a high-voltage plug, passes through the central aperture of a metal revolving part, known as a cap, which has a flat side located opposite the high-voltage device with a milled recess adapted to the application of a toric joint about this central aperture, this revolving part having an outer diameter larger than that of the high-voltage plug, whereas the central aperture has a diameter smaller than that of this plug;
the eliminator has a conduit of impermeable plastics material disposed about the coaxial cable supplying the high voltage to the injectors, the sealing tightness being supplemented by the mounting of two stuffing boxes, one of which is placed about the input of the cable into the injector and the other of which is placed at the input of the revolving part;
the revolving part has a threaded cylindrical extension on the side oriented towards the supply device, this extension penetrating, via an aperture of diameter larger than that of the high-voltage plug, into a cabinet enclosing the electricity supply, the toric joint being applied in a sealing-tight manner to an outer wall of this cabinet by screwing a threaded ring on to this threaded extension;
the electricity supply circuit of the injector(s) comprise(s) high-voltage transformers the primary winding of which is connected to the output of a synchronous static relay supplied by an alternating voltage source, e.g. by the mains;
the application of primary voltage to the static relay is controlled by a time-delayed relay whose coil is supplied from a pressure-sensitive switch connected to the compressed gas distribution network supplying the injector(s);
the injector(s) is/are supplied with compressed air at a pressure of between 12 and 5 bars, at a dew point of between −19° C. and 40° C.;
the eliminator comprises an even number of injectors, each group of injectors being formed of injectors having voltage-current properties which are as similar as possible, each of the two injectors being connected to an opposite polarity of an alternating supply; and
for each group of two injectors, the primary winding of the high-voltage transformer supplying a first injector and the primary winding of the high-voltage transformer supplying a second injector are in phase opposition.

In the following description, given by way of example, the attached drawings are referred to, which show:

FIG. 1, a side view of a static electricity eliminator according to the invention showing more particularly the structure of the injector;

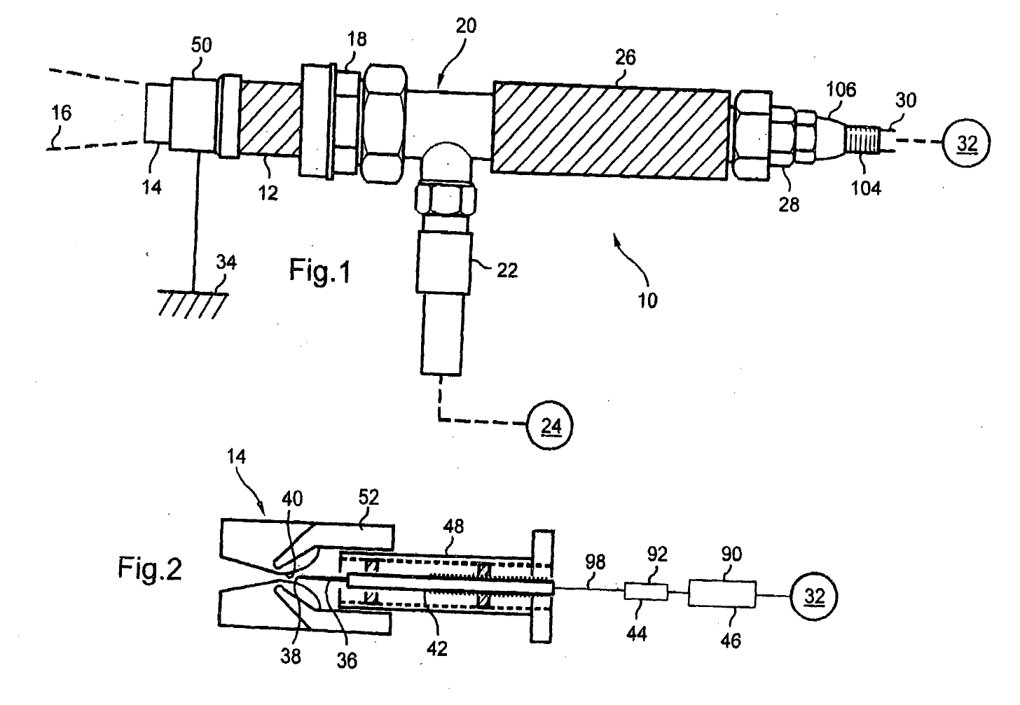

FIG. 2, a partial view in section showing the nozzle, the insulating mantle cooperating with the nozzle, as well as the needle and its support disposed inside the mantle;

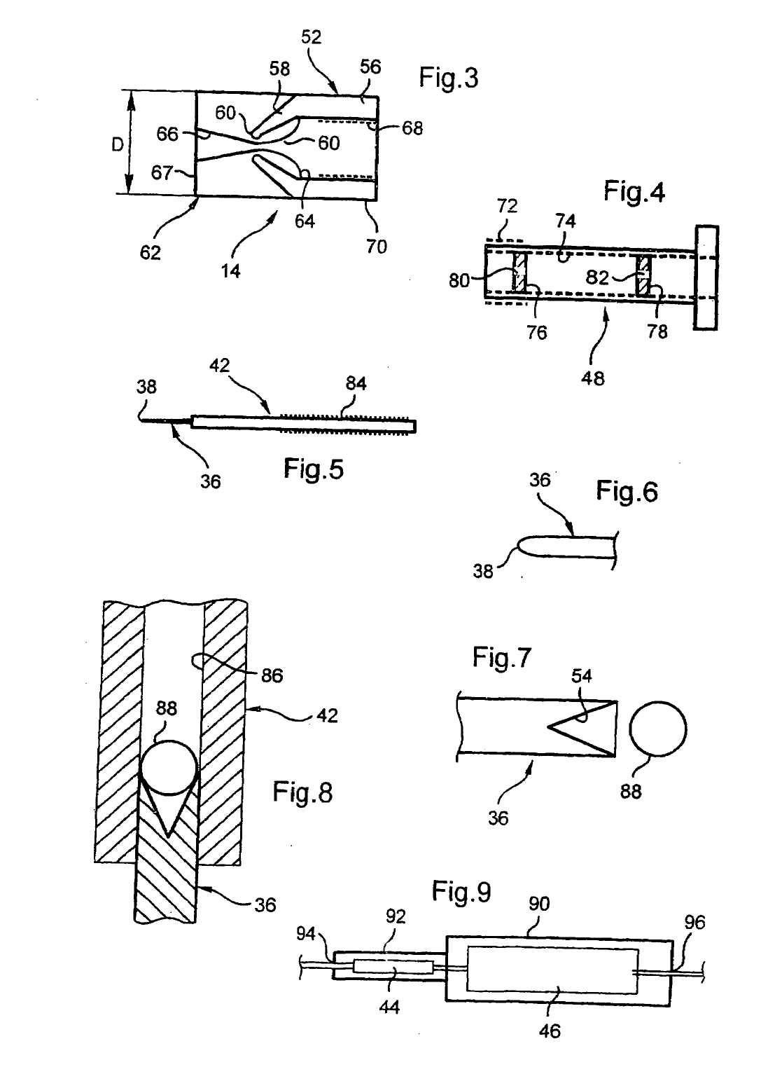

FIG. 3 is a section view of the nozzle of FIG. 2;

FIG. 4 is a section view of the insulating mantle of FIG. 2;

FIG. 5 is a section view of the support and of the needle of FIG. 2;

FIG. 6 is a view on an enlarged scale of the point of the needle;

FIG. 7 is a view in section on an enlarged scale of the rear end of the needle and a ball;

FIG. 8 shows the mounting of the rear end of the needle in the support via the ball;

FIG. 9 shows two envelopes intended to receive respectively an electrical resistor and a capacitor forming part of the supply to the point;

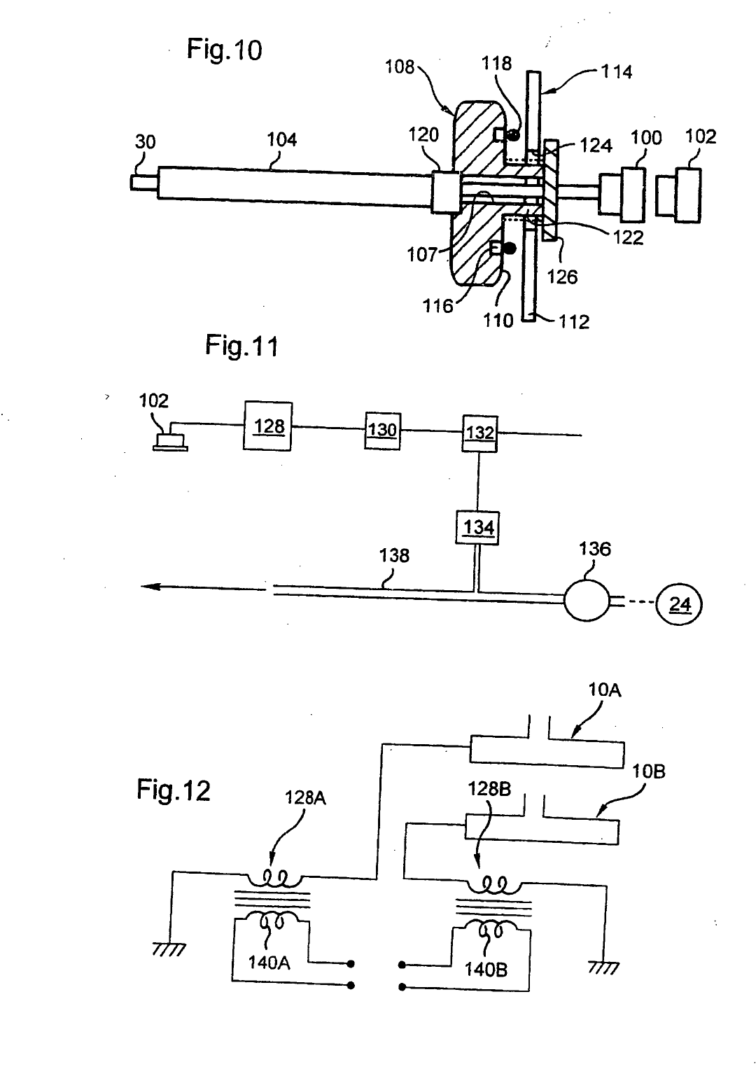

FIG. 10 shows connecting means of the injector to a supply and control cabinet;

FIG. 11 is a block diagram of the supply and control cabinet of FIG. 10; and

FIG. 12 shows diagrammatically the electrical supply of two injectors according to the invention.

We refer first of all to FIG. 1, which shows a static electricity eliminator designated by the reference 10 as a whole. This eliminator comprises an injector body of generally elongate shape comprising a metal tube 12 which forms the front of the injector body and ends with a nozzle 14 through which the ejection of an aerosol takes place under the effect of a supersonic jet as is indicated by the reference 16. The metal tube 12 is connected at its rear part, via a dismountable conductor assembly 18, to a T-shaped connection 20 which has a lateral feeding pipe 22 for the supply of compressed gas, in this case compressed air from a compressed air source 24.

At its other end, the connection 20 is connected to a metal tube 26 which forms the rear of the injector body and which is connected to a fixing device 28. This is connected to a coaxial cable 30 for the supply to the point (described below) housed by the nozzle, from a high-voltage supply source 32. Furthermore, the metal part of the injector body is connected to earth as is indicated by the reference 34.

As will be seen from FIG. 2, the nozzle 14 houses internally a needle 36 ending with a point 38, also known as the “corona point” located close to an inner throat 40 which the nozzle defines. The rear end of the needle 36 is connected to a threaded support 42 which is in turn connected to a resistor 44 and a capacitor 46, both housed inside the metal tube 26 (FIG. 1). These two components are connected to the coaxial tube 30 mentioned above.

The support 42 is mounted inside an insulating mantle 48 which is itself housed inside the tube 12. A cylindrical ring 50 (FIG. 1) is contrived to slide with gentle friction over the rear part of the nozzle 14 and over the cylindrical metal tube 12 in order to be fixed at a selected position thereon in order to ensure conductive contact between the nozzle and the metal tube. This conductive contact is effected with a metal insert 52 (FIGS. 2 and 3) which the nozzle 14 comprises and which will be described below.

According to the invention, the corona point is formed by a chromium-steel surgical needle 36, whose point 38 has a diameter smaller than 30 micrometres (FIG. 6). The radius of curvature of the point 38 is advantageously comprised between 10 and 20 micrometres.

On the side opposite the point, the needle ends with a circular base having a conical aperture 54 (FIG. 7) for mounting the needle in the support 42, as will be seen below.

We refer now more particularly to FIG. 3 to describe the structure of the nozzle 14. The metal insert 52 comprises a hollow cylindrical part 56 extending forward with a conical part 58 ending with a flange 60 oriented inwards. The whole is moulded in a cylindrical mould 62 from insulating material, an epoxy material in the example, so as to cover with insulator the conical part 58 and the flange 60 both outside and inside, and the front of the inner cylindrical part. The shape of the mould must be such that this insulator covers the converging part 64 of the nozzle and its throat 60, the diverging part 66 of the nozzle being housed in a cylindrical extension composed of epoxy material and having the same outer diameter D as the metal insert 42. The appropriate shapes of the converging part and the diverging part of the nozzle are obtained at moulding by selecting the shape of the mould. Correction of the insulating material by means of milling can if necessary improve the profile of the supersonic nozzle. The thicknesses of insulating material inside the nozzle 14 are so selected that the maximum voltage applied to the needle is lower than the breakdown voltage of the insulator.

The nozzle 14 has a flat outer face 67 obtained by milling of the cylindrical shape 62 obtained by moulding. The hollow cylindrical part 56 forming the metal insert 42 of the nozzle is equipped at its rear with a female thread 68 and comprises an outer wall 70 having the same diameter D as the metal tube 12 (FIG. 1) which protects the front part of the injector and is located adjacent to the metal insert.

The insulating mantle 48 (FIG. 4) has a threaded front part 72 adapted to screw into the female thread 68 of the rear end of the metal insert. This insulating mantle thus makes it possible to isolate the needle electrically from the body of the injector. As already indicated, the insulating mantle 48 is surrounded by the metal tube 12, the ring 50 sliding with gentle friction over the insert 52 of the nozzle and over the metal tube 12.

The insulating mantle 48 comprises a female thread 74 into which are screwed two metal rings 76 and 78 intended to carry the metal support 42 of the needle. The ring 76 comprises a passage 80 for the metal support, whereas the ring 78 comprises a threaded passage 82 to cooperate with the male thread 84 (FIG. 5) of the metal support 42. Furthermore, the two metal rings are penetrated by apertures (not shown) to allow the passage of the compressed gas.

The threaded support 42 which the needle 36 carries is contrived to be screwed or unscrewed into the fixing device formed by the rings 76 and 78 in order to effect approximate adjustment of the position of the point 38 of the needle 36 relative to the throat 40 of the nozzle. Furthermore, the relative position of the point of the needle and the throat of the nozzle can be adjusted rapidly and with precision without dismantling the injector, by screwing or unscrewing the threaded part 72 of the insulating mantle 48.

We refer now to FIGS. 7 and 8 in order to describe the mounting of the rear end of the needle 36 in the metal support 42. As FIG. 8 shows, the rear end of the needle is engaged inside a recess 86 in the form of a hollow cylinder formed at the front of the metal support 42, this recess having a diameter greater by several hundredths of a millimetre than that of the needle. The rear end of the needle is fixed in the cylindrical recess 86 by widening the walls of the conical recess 54 of the needle following crushing of these walls between the inner wall of the support and a ball 88 of a ball-point pen, of an appropriate diameter. This mounting is effected by crimping in the following manner. The needle is held vertically in a vice with the point downwards. The ball 88 is placed on the needle and the support 42 is driven over the assembly so as to surround the ball and the needle. Then the support is tapped vertically with a light hammer blow, so that the ball is driven into the housing and crushes the walls of the conical part 54 of the needle against the inner walls of the support 42. This process makes it possible to obtain a light and non-deformable assembly.

The capacitor 46 (FIG. 2) must be capable of withstanding a continuous voltage of 16 kilovolts at the terminals whereas the protection resistor 44 must have a value of between 1 MΩ and 100 MΩ. These two components are disposed in series in two insulating envelopes (FIG. 9), the insulating envelope 90 of the capacitor 46 and the insulating envelope 92 of the resistor 44 being assembled end to end. The assembly is made sealing-tight at the passages 94 and 96 of the connections by insulating varnish so as to protect these components against moisture in the air circulating in the injector. The two envelopes 90 and 92 are housed inside the metal tube 26 shown in FIG. 1.

The connection 20 (FIG. 1) forms an electrical contact with the tubes 12 and 26 to ensure the continuity of the conductive link between the front and rear of the injector. The cylindrical ring 50 surrounding the metal insert 52 and the front of the tube 12 makes it possible to keep the insert at the potential of the mass of the injector, i.e. at earth potential, although the nozzle is screwed on to the insulating mantle.

In its median part, the body of the injector is connected by dismountable assembly 18 to the connection 20 via which compressed air is introduced. An electrical link formed by a supple wire 98 (FIG. 2) connecting the resistor 44 to the needle 36 traverses this part of the injector from back to front. Insulating parts (not shown) are disposed internally in this region to reinforce the maintenance at voltage of the components and of the metal parts connected to high voltage.

The metal tube 26 is a cylindrical tube of a diameter which is sufficient to contain the resistor and the capacitor and their respective envelopes. The tube 26 is in electrical contact with the T-shaped connection 20.

The metal tube 26 protecting the rear of the injector is in contact with the fixing device 28 which acts as an anchor for the coaxial cable 30. This metal device is itself in contact with a metal casing (not shown) of the cable which is connected to earth.

The coaxial cable 30 ends on the side of the high-voltage electricity supply circuit 32 with a high-voltage plug 100 capable of adapting to a high-tension seat 102 (FIG. 10). The cable is surrounded with a conduit of impermeable plastics material 104, here a ringed conduit, fixed to the injector via a stuffing box 106 in order to ensure sealing-tightness of the assembly (FIG. 1).

The cable 30 passes through the central aperture 107 of a metal revolving part 108 (known as the “cap”), e.g. composed of stainless steel, which has a flat side 110 located opposite a wall 112 of a high-voltage device 114, e.g. a high-voltage cabinet (FIG. 10). The flat side 110 comprises a milled recess 116 in the form of a circular groove adapted to the mounting of a toric joint 118 about the central aperture. This revolving part 108 has an outer diameter larger than that of the high-voltage plug 100, whereas the central aperture 107 has a diameter smaller than that of the plug.

The sealing-tightness of the conduit 104 disposed about the coaxial cable 30 is supplemented by the mounting of a second stuffing box 120 located at the input of the revolving part 108. The revolving part 108 has a threaded cylindrical extension 122 on the side oriented towards the power supply device 114, this extension penetrating via an aperture 124 of larger diameter than that of the high-voltage plug 100 into the wall 112 of the cabinet 114 enclosing the electricity supply. The joint 118 is applied in a sealing-tight manner to the outer wall of this cabinet by screwing a threaded ring 126 on to this threaded extension.

In the configuration thus obtained, the revolving part 108 is inseparable from the coaxial cable since it is held on the one side by the injector and on the other by the plug 100.

As is shown in FIG. 11, the electrical supply circuit of the injector(s) has high-voltage transformers 128, the primary winding of which is connected to the output of a synchronous static relay 130 supplied by an alternating voltage source, e.g. by the mains. The application of the primary voltage to the static relay 130 is controlled by a time-delayed relay 132, whose coil is supplied from a pressure-sensitive switch 134 connected to the compressed gas distribution network supplied to the injector (s).

In the example, each injector is supplied with compressed air from the source 24 and through a supply valve 136, which controls a conduit 138 connected to the feeding pipe 22 of the T-shaped connection 20. The needle of the injector(s) is supplied with high voltage of between 6000 and 9000 volts by a cabinet containing the transformers 128 which raise the voltage from the mains voltage. Each injector is connected to a transformer completely covered in a suitable insulator. The voltage is supplied to the injector via the coaxial cable 30 which ends with the plug 100 adaptable to the seat 102. The output connections of the transformers are connected one to earth and the other to the seat allocated to the corresponding injector. The injectors are protected against excess current by fuses inserted in the circuit connected to the primary winding of the transformers 128. These are protected against heating up by a thermal relay inserted in their covering.

The synchronous static relay 130 plays an important part. Indeed, the coaxial cable connected to the injector behaves like a delay line for rapid signals, such that these signals undergo reflection at the end of the line. Since the corresponding impedance at a corona point is very high (open line), this reflection is carried out without a change of sign. For example, if upon closing of the primary circuit of the transformer a level of 10 500 volts is applied at the seat/plug assembly, a reflected signal of 10 500 volts is superimposed virtually instantly on this level, the plug/seat assembly being then subjected to a voltage of 21 000 volts, which causes an arc and a short-circuit to earth.

The synchronous static relay 130 makes it possible to close the primary circuit which supplies the transformer only upon passage through zero of the voltage of the mains. This prevents random closure produced from a mechanical switch, a closure which may be produced at any moment in the cycle and which produces an input voltage level in the coaxial line, a level which may possibly correspond in the secondary to the peak voltage (i.e. 10 500 volts for a secondary supplying 7000 volts in effective value). The presence of this static relay is essential to ensure safety and reliability of functioning of the plant.

The time-delayed relay 132 plays an essential part. Since the injector is located in a region with an explosion risk, it must under no circumstances present risks of arking of electric discharges at the nozzle. This is defined to operate without arking under normal pressure conditions corresponding to the nominal flow rate. Consequently, if the conditions are not achieved, the relay 132 is closed, which applies the voltage of the mains to the primary winding of the transformers.

Moreover, as at the opening of the compressed air supply valve 136, it is possible that the pressure-sensitive switch 134 records the nominal pressure before this pressure is obtained at the injectors, the relay 132 is time-delayed, which makes it possible to apply the voltage to the injectors only after the nominal flow rate of the compressed air is obtained. The choice of corresponding delay is evaluated according to the structure of the pneumatic circuit associated with the eliminator, but it is not very constraining to select a delay very much higher than the few seconds which correspond to the time for setting up the permanent flow rate of compressed air in the pneumatic circuit associated with the eliminator.

The assembly shown in FIG. 10 makes it possible to connect the coaxial cable 30 (plug 100 and seat 102) inside the cabinet 114, which is protected against dusts and water sprays. This cabinet is advantageously formed from a composite material or stainless steel. The contrivance of the revolving part 108 with the joint 118 and the ring 126 makes possible easy dismantling of the injector. When the device is assembled, the part 108 seals the aperture 124, the joint 118 being strongly supported on the outer wall of the cabinet by screwing of the ring 126 on to the threaded cylinder 122 penetrating inside the cabinet. During the operation phase, the sealing-tightness of the assembly is therefore ensured by the joint 118, and by the two stuffing boxes 106 and 120. To dismantle the injector, it suffices to separate the plug 100 from the seat 102 and to unscrew the ring 126, which frees the part 108 and leaves a large passage for the plug 100 connected to the end of the coaxial cable.

In the invention, the or each injector is supplied with compressed air of between 12 and 5 bars, at a dew point of between −19° C. and −40° C. In fact, the compressed air used must, once decompressed, have neither too much nor too little humidity. Over-humid air leads to condensation of a film of water on the insulating parts which support the needle holder and brings about short-circuiting to earth of the corona point. Air that is too dry does not make it possible to reach the expected performance of the process, since the conveying of electrical charges by the supersonic jet requires a sufficient number of carriers formed by condensation of ice on the ions by the corona discharge, and this number decreases very rapidly below a certain humidity.

For a plant operating inside the production factory, the optimum conditions of current conveyed through the nozzle by the aerosols correspond to a dew point of −19° C. These conditions are obtained for example in a refrigerating dryer supplied with humid compressed air at a pressure of 6 bars, through whose coil water at a temperature of 3° C. passes. For a dew point of 40° C., the intensity of the current conveyed is divided by two.

For a plant operating outside, i.e. subject during winter to temperatures much lower than 0° C., it is prudent to select a dew point of 40° C. in order to avoid condensation at the nozzle.

In the case of FIG. 12, the eliminator comprises at least one group of two nozzles 10A and 10B supplied from two transformers 128A and 128B. These two transformers have respective primaries 140A and 140B supplied in phase opposition.

In fact, in order to come as close as possible to neutrality of the mixture of negative and positive ions resulting from the sublimation of aerosols, the simplest process consists in using an even number of injectors equipped so as to have emission properties (currents as a function of the high voltage applied) which are as similar as possible. This is obtained by connecting, for each group of injectors, a first injector to one phase of an alternating high-voltage supply and the second injector to the opposite phase.

Thus, each moment, a current is injected having a total intensity of a value very close to zero, which avoids the appearance of a large bulk, which may give rise to expulsion of part of the ions produced towards the walls and may possibly bring to a high potential any metal object located in the plant which, due to negligence of the installers, might not have been connected to earth.

Thus an even number of injectors is used, each group of injectors formed of injectors having voltage-current properties as similar as possible, each of the two injectors being connected to an opposite polarity of an alternating supply.

Since this situation may give rise to the appearance of electric arking capable of producing an explosion, it is imperative that the injection of charged aerosols into the enclosure where the product to be treated is cannot generate increases in potential on metal objects isolated from earth, which is guaranteed precisely by the balancing of immediate currents, positive and negative, injected by the eliminator and which is a consequence of the arrangements cited above.

The invention is particularly applied to the processing of polymers.

1-22. (canceled)

23: A static electricity eliminator comprising:
at least one injector having a body that defines a supersonic nozzle for holding a compressed gas;
a corona point located close to a throat of the nozzle; and
an electric supply circuit connected to the corona point,
wherein the corona point is formed by a surgical needle composed of chromium-steel, whose point has a diameter of less than 30 micrometres.

24: The eliminator according to claim 23, wherein the supersonic nozzle is formed of a metal insert including a hollow cylindrical part extending forward by a conical part ending with a flange oriented inwards, the whole being molded from an epoxy insulator so as to cover with insulator the conical part and its flange both outside and inside, and a front of the inner cylindrical part.

25: The eliminator according to claim 24, wherein the hollow cylindrical part forming the metal insert of the nozzle is equipped at its rear part with a female thread and has an outer wall having a same diameter as a cylindrical metal tube that protects a front part of the injector and that is located adjacent to the metal insert.

26: The eliminator according to claim 25, wherein the needle is supported by an insulating mantle having a threaded front part configured to screw into the female thread of the rear end of the metal insert of the nozzle.

27: The eliminator according to claim 26, further comprising a metal ring configured to slide with gentle friction over the rear part of the nozzle and over the cylindrical metal tube and to be fixed thereon in a selected position so as to ensure conductive contact between the metal insert of the nozzle and the metal tube.

28: The eliminator according to claim 26, wherein the insulating mantle is equipped internally with a fixing device formed by two metal rings penetrated by apertures to allow the passage of the compressed gas, and one of which at least is equipped with a thread.

29: The eliminator according to claim 28, wherein the needle is carried by a threaded support configured to be screwed or unscrewed in the fixing device to effect approximate control of the position of the point of the needle relative to the throat of the nozzle.

30: The eliminator according to claim 29, wherein the relative position of the point of the needle and the throat of the nozzle can be adjusted rapidly and with precision, without dismantling the injector, by screwing or unscrewing the nozzle on the front threaded end of the insulating mantle, which surrounds the needle support.

31: The eliminator according to claim 23, wherein the needle comprises a conical recess formed at a rear end located opposite the point.

32: The eliminator according to claim 31, wherein the rear end of the needle is engaged inside a recess in a form of a hollow cylinder formed at the front of a metal support in a shape of a cylinder, the recess having a diameter larger by several hundredths of a millimeter than that of the needle, and wherein the rear end of the needle is fixed in the cylindrical recess by widening walls of the conical recess of the needle following crushing of the walls between an inner wall of the support and a ball of a ball-point pen of appropriate diameter.

33: The eliminator according to claim 35, further comprising a metal T-shaped connection allowing introduction of compressed gas into the injector and interposed between a metal tube protecting a front of the injector and another metal tube protecting a rear of the injector so as to form a contact with the tubes to ensure continuity of a conductive link between the front and rear of the injector.

34: The eliminator according to claim 33, wherein the metal tube protecting the rear of the injector is in contact with a metal fixing device configured to anchor a coaxial cable for supplying a high voltage to the needle, the metal fixing device being in contact itself with a metal casing of this cable connected to ground.

35: The eliminator according to claim 23, wherein the electricity supply circuit of the corona needle includes two components in series between the needle and a secondary of a transformer that supplies thereto the high voltage, of a capacitor of a value of between 20 pF and 200 pF, and a resistor of a value of between 1 MΩ and 100 MΩ.

36: The eliminator according to claim 35, wherein the capacitor and the resistor are located in an insulating envelope including apertures formed for passage of input and output connections that are covered with a thermosetting insulating polymer to prevent penetration of damp air into the envelope.

37: The eliminator according to claim 34, wherein the coaxial cable supplying the high voltage ends on the side of an electrical supply circuit with a high-voltage plug, passes through the central aperture of a revolving metal part, which has a flat side located opposite the high-voltage device, with a milled recess configured to mount a toric joint about the central aperture, the revolving part having an outer diameter larger than that of the high-voltage plug, whereas the central aperture has a diameter smaller than that of the plug.

38: The eliminator according to claim 37, further comprising a conduit composed of impermeable plastics material disposed about the coaxial cable supplying the high voltage to the injectors, the sealing-tightness being supplemented by mounting of first and second stuffing boxes, the first stuffing box placed about an input of the cable into the injector and the second stuffing box placed at an input of the revolving part.

39: The eliminator according to claim 35, wherein the revolving part includes a threaded cylindrical extension on a side oriented towards the supply device, the extension projecting via an aperture of diameter greater than that of the high-voltage plug into a cabinet enclosing the electricity supply, a toric joint being applied in a sealing-tight manner to an outer wall of the cabinet by screwing a threaded ring on to the threaded extension.

40: The eliminator according to claim 23, wherein the electricity supply circuit of the injector has high-voltage transformers, whose primary winding is connected to an output of a synchronous static relay supplied by an alternating voltage source.

41: The eliminator according to claim 40, wherein application of a primary voltage to the static relay is controlled by a time-delayed relay whose coil is supplied from a pressure-sensitive switch connected to the distribution network of compressed gas supplied to the at least one injector.

42: The eliminator according to claim 41, wherein the at least one injector is supplied with compressed air at a pressure of between 12 and 5 bars, at a dew point of between −19° C. and −40° C.

43: The eliminator according to claim 23, further comprising an even number of injectors, each group of two injectors being formed of injectors having voltage-current properties that are as similar as possible, each of the two injectors being connected to an opposite polarity of an alternating supply.

44: The eliminator according to claim 43, wherein for each group of two injectors, the primary winding of the high-voltage transformer supplying a first injector and the primary winding of the high-voltage transformer supplying a second injector are in phase opposition.
